(19) United States
(12) Patent Application Publication
(10) Pub. No.: US 2024/0259348 A1
(43) Pub. Date: Aug. 1, 2024

(54) DIRECTED ISOLATED NETWORK CONNECTIVITY

(71) Applicant: DELL PRODUCTS L.P., Round Rock, TX (US)

(72) Inventors: Eric Bruno, Shirley, NY (US); Daniel Cummins, Hudson, NH (US); Bradley Goodman, Nashua, NH (US); Ana Smith, Chicago, IL (US); Jeremy Phelps, Bowling Green, KY (US)

(21) Appl. No.: 18/163,006

(22) Filed: Feb. 1, 2023

(51) Int. Cl. H04L 9/40

(52) U.S. Cl. CPC H04L 63/0281; H04L 63/0823; H04L 63/168

(57) ABSTRACT

An edge compute network includes an endpoint device and an information handling system. The endpoint device includes a network interface configured to operate with no open inbound network ports and to provide an outbound request on a predetermined network port. The information handling system includes first and second reverse proxies and instantiates an endpoint orchestrator. The first reverse proxy receives the outbound request and provides the outbound request to the second reverse proxy. The second reverse proxy provides the outbound request to the endpoint orchestrator which authenticates the endpoint device based upon the outbound request and provides authentication information to the endpoint device. The endpoint device authenticates the information handling system based upon the authentication information, and opens the predetermined network port to the information handling system in response to authenticating the information handling system.

### FIELD OF THE DISCLOSURE

This disclosure generally relates to information handling systems, and more particularly relates to providing directed isolated network connectivity.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An edge compute network includes an endpoint device and an information handling system. The endpoint device includes a network interface configured to operate with no open inbound network ports and to provide an outbound request on a predetermined network port. The information handling system includes first and second reverse proxies and instantiates an endpoint orchestrator. The first reverse proxy receives the outbound request and provides the outbound request to the second reverse proxy. The second reverse proxy provides the outbound request to the endpoint orchestrator which authenticates the endpoint device based upon the outbound request and provides authentication information to the endpoint device. The endpoint device authenticates the information handling system based upon the authentication information, and opens the predetermined network port to the information handling system in response to authenticating the information handling system.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an edge compute network according to an embodiment of the current disclosure;

FIG. 2 is a block diagram of an edge compute endpoint of the edge compute network of FIG. 1; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures as needed or desired.

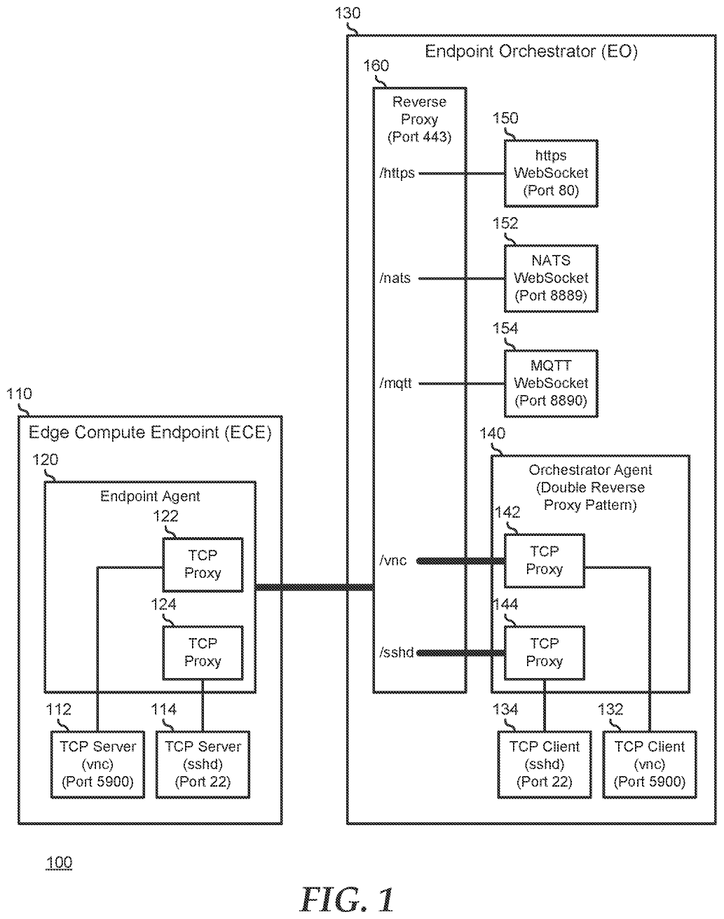

FIG. 1 illustrates an edge compute network 100 including an edge compute endpoint (ECE) 110 and an endpoint orchestrator (EO) 130. Network 100 represents a distributed computing system where distributed network endpoints are connected to a central server or orchestrator that monitors, manages, and maintains the endpoints. In monitoring ECE 110, EO 130 may be configured to request and receive various information from the ECE related to the operation of the ECE and to the functions performed by the ECE. In managing ECE 110, EO 130 may be configured to direct the operations and functions performed by the ECE. In maintaining ECE 110, EO 130 may be configured to ensure that the operations and functions are operating correctly, such as by providing firmware updates, operational settings, and the like, as needed or desired.

ECE 110 may be understood to the exemplary of multiple ECEs within network 100 that are all similarly connected to EO 130. An example of an edge compute network may include a distributed sensor or control network, a telecom network such as a 5G network, a network of Internet-of-Things (IOT) devices, or the like. As such, the computing, sensing, controlling, processing, or other functions of ECE 110 may be understood to be determined by a manufacturer of the ECE. Moreover, it should be understood that the functions and features of the various ECEs in an edge compute network may be similar to each other or may be different from each other, as needed or desired. The provision of the computing, sensing, controlling, processing, or other functions of ECEs are known in the art and will not be further described herein, except as may be needed to illustrate the current embodiments.

The network connectivity of ECE 110 to EO 130 may represent a closed or private network that is accessible only to the EO, the ECE, and any additional ECEs on the network. However, in a typical case, the network connectivity of ECE 110 to EO 130 may represent a publicly accessible network, such as the Internet, a corporate internet, a telecommunications access network, or the like. In this case, ECE 110 is subject to a wide variety of attack vectors that may be performed by malicious actors to corrupt the operations of network 100.

In the current embodiments, network 100 provides directed, isolated, and secure connectivity between ECE 110 and EO 130. The connectivity is directed in that only ECE 110 initiates the connectivity with EO 130. The connectivity is isolated in that all bidirectional, full-duplex traffic is sent over the directed connection, and the connectivity is supported over a single network port, such as 443, for firewall-friendly traffic, and to limit the requirements on information technology (IT) resources. The connectivity is secure in that all elements of network 100 are mutually attested and authenticated, such as by mutual Transport Layer Security (TLS) sessions. Once a directed, isolated, and secure session is established between ECE 110 and EO 130, the EO employs a reverse proxy to direct various ECE requests to various WebSocket listeners associated with the particular ECE requests. In this, a double reverse proxy pattern is employed in ECE 110 and in EO 130 to support the tunneling of various native protocols over the WebSocket connections. The native protocols may include virtual network computing (VNC) sessions, Secure Shell Daemon (SSHD) sessions, Transmission Control Protocol (TCP) sessions, Hypertext Transfer Protocol-Secure (HTTPS) sessions, Neural Autonomic Transport System (NATS) sessions, MQ Telemetry Transport (MQTT) sessions, or the like.

ECE 110 includes TCP servers 112 and 114, and an endpoint agent 120. TCP server 112 is associated with a VNC service which may typically be associated with Port 5900. TCP server 114 is associated with a SSHD service which may typically be associated with Port 22. Endpoint agent 120 includes a TCP proxy 122 that serves as a proxy for TCP server 112, and a TCP proxy 124 that serves as a proxy for TCP server 114.

EO 130 includes TCP clients 132 and 134, an orchestrator agent 140, WebSocket services 150, 152, and 154, and a reverse proxy 160. TCP client 132 is associated with a VNC service which may typically be associated with Port 5900. TCP client 134 is associated with a SSHD service which may typically be associated with Port 22. Orchestrator agent 140 includes a TCP proxy 142 that serves as a proxy for TCP client 132, and a TCP proxy 144 that serves as a proxy for TCP client 134. WebSocket service 150 is associated with a HTTPS service which may typically be associated with Port 80. WebSocket service 152 is associated with a NATS service which may typically be associated with Port 8889. WebSocket service 154 is associated with a MQTT service which may typically be associated with Port 8890. It will be understood that EO 130 may include one or more additional service, such as additional TCP clients or WebSocket services, as needed or desired.

Reverse proxy 160 faces ECE 110 on a single dedicated port (for example port 443). Connectivity between ECE 110 and EO 130 is directed in that the ECE is configured to initiate the connectivity with the EO via the dedicated port (port 443), but to not respond to unsolicited incoming traffic. That is, ECE 110 operates with no open inbound network ports to prevent malicious access to the ECE. Further, the connectivity between ECE 110 and EO 130 is isolated in that all bidirectional, full-duplex traffic is sent over the directed connection. It will be understood that the use of a single dedicated port simplifies firewall rules and limits the requirements for IT support. The directed, isolated connection between ECE 110 and EO 130 is established based upon the following rules:
Rule A: Network connections are established in one direction only, from ECE 110 to EO 130 only, providing directed connectivity.
Rule B: All network data is communicated using message-oriented middleware with named and authenticated queues to assure directed communication that is isolated between intended edge nodes (for example ECE 110) only.
Rule C: Bi-directional network communication, regardless of request origin, is intercepted using the double-reverse proxy pattern and sent over the existing directed connection, which was initially established according to Rule A, above.

Afterward the establishment of the directed, isolated connection between ECE 110 and EO 130, reverse proxy 160 operates to demultiplex traffic from the ECE to the target of the traffic (e.g., orchestrator agent 142 and WebSocket services 150, 152, and 154).

In establishing the directed, isolated connection between ECE 110 and EO 130, the EO implements a double-reverse-proxy function, where, in response to a request from the ECE on the dedicated port, the EO operates to respond with commands to the ECE to open a reversed connection back to the EO. With the reversed connection established, EO 130 can operate to monitor, manage, and maintain ECE 110. All communications between ECE 110 and EO 130 are authenticated and mutually attested, such as by sharing mutual Transport Layer Security (TLS) certificates. In particular, ECE 110 operates to initiate a connection request on the dedicated port (Port 443), and verifies the identity of EO 130 via a root server certificate authority. The connection request further includes a client key-pair from ECE 110. Reverse proxy 160 intercepts the connection request and triggers a client verify process to authenticate ECE 110 via the root server certificate authority. If the attestation process succeeds, then the connection between ECE 110 and EO 130 is allowed. If the attestation process fails, then the connection is disallowed or other remediation processes may be provided, as needed or desired.

With the directed and isolated connection established between ECE 110 and EO 130 and fully with the ECE and the EO fully attested, as indicated by the dark connection between the ECE and the EO, all further traffic between the ECE and the EO is conducted on the resulting virtual private network (VPN). In particular, all traffic, regardless of the original native protocol, is transformed and sent as encrypted web traffic over the secure isolated network connection and converted back to original protocol at the receiver. In particular, in the ECE-to-EO direction, a protocol initiator that operates HTTPS traffic will be transmitted on the directed, isolated connection to reverse proxy 160 and routed to HTTPS WebSocket 150. Similarly, NATS, MQTT, VNC, and SSHD traffic will be transmitted on the directed, isolated connection to reverse proxy 160 and routed to respective NATS WebSocket 152, MQTT WebSocket 154, TCP clients 132 and 134. Any other supported protocols will likewise be transmitted on the directed, isolated connection to reverse proxy 160 and routed to an associated client or agent, as needed or desired.

The establishment and use of the directed, isolated, and attested connection provides a multi-layered approach to network communication security. In particular, the mutual attestation ensures both endpoints are attested and authenticated members of edge compute network 100. Further, the data transfers can be secured and attested by signing all data with the receiver's public key, such as utilizing an onboard Trusted Platform Module (TPM) or other secure storage device, and checking the data with the receiver's private key. Finally, sending data to the ECE only in response to a request from the ECE on a single port ensures that the ECE remains secure from tampering.

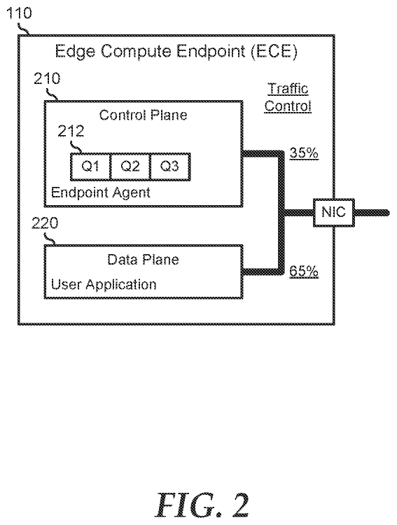

FIG. 2 illustrates ECE 110, including a control plane 210 and a data plane 220. Control plane 210 represents a segregated data access for the monitoring, managing, and maintaining the operations of ECE 110. Control plane 210 may be associated with an endpoint agent that receives instructions from EO 130 for the monitoring, management, and maintenance of ECE 110. Data plane 220 represents another segregated data access for sending and receiving data associated with a user application instantiated on ECE 110, as needed or desired. For example, where ECE 110 represents a sensor device, data plane 220 may be utilized by EO 130 to retrieve sensor data, or where the ECE represents a control device, the data plane may be utilized by the EO to send control commands to the ECE. By segregating control plane 210 and data plane 220, ECE 110 provides a multi-layered implementation for enforcing quality-of-service (QOS) rules. In particular, it will be understood that QoS typically is provided to channel communications in order to ensure that no particular type of communication monopolizes all of the data bandwidth between ECE 110 and EO 130.

Control plane 210 includes data queues 212 that are each associated with a different QoS level, and that control inbound and outbound traffic priority and flow control. ECE 110 further implements bandwidth control to ensure that each communication channel is limited to a maximum percentage of the total bandwidth. As illustrated here, control plane 210 is limited to a maximum of 35% of the total bandwidth, and data plane 220 is limited to a maximum of 65% of the total bandwidth. In particular, ECE 110 host network bandwidth quotas to the control-plane communication channels to ensure sufficient host bandwidth for data-plane communication. The QOS prioritization of messaging guides how the control-plane messages are transmitted, and within a maximum percentage of total bandwidth for the host.

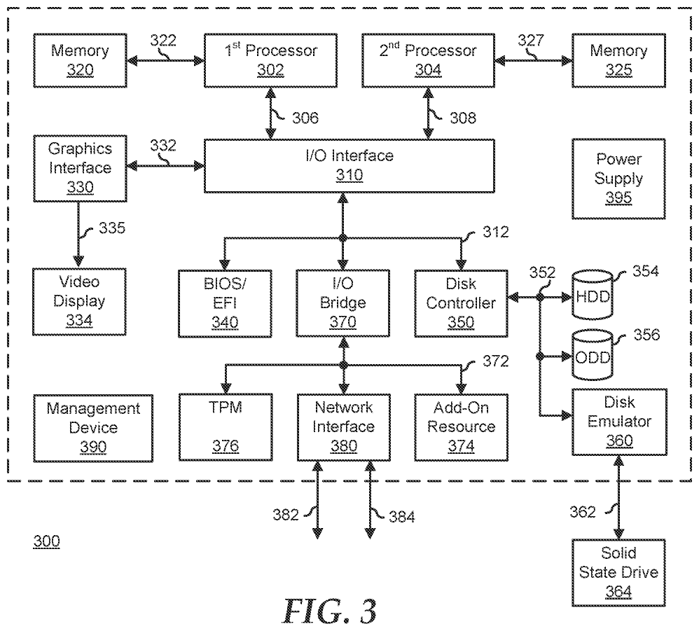

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320 and 325, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 335 to a video display 334. In a particular embodiment, information handling system 300 includes separate memories that are dedicated to each of processors 302 and 304 via separate memory interfaces. An example of memories 320 and 325 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on a separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 includes a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An edge compute network, comprising:
an endpoint device including a network interface configured to operate with no open inbound network ports and configured to provide a first outbound request on a predetermined network port; and
an information handling system including a first reverse proxy and a second reverse proxy, and configured to instantiate an endpoint orchestrator, the first reverse proxy configured to receive the first outbound request on the predetermined network port and to provide the first outbound request to the second reverse proxy, the second reverse proxy configured to provide the first outbound request to the endpoint orchestrator, and the endpoint orchestrator configured to authenticate the endpoint device based upon the first outbound request and provide authentication information to the endpoint device to authenticate the information handling system to the endpoint device;
wherein the endpoint device is further configured to authenticate the information handling system based upon the authentication information, and to open the predetermined network port to the information handling system in response to authenticating the information handling system.

2. The edge computing network of claim 1, wherein, in response to opening the predetermined network port, the endpoint device is further configured to provide a second outbound request associated with one of a plurality of WebSockets instantiated on the information handling system to the endpoint device.

3. The edge computing network of claim 2, wherein the first reverse proxy is further configured to receive the second outbound request and to forward the second outbound request to the particular WebSocket.

4. The edge computing network of claim 1, wherein, in response to opening the predetermined network port, the information handling system is configured to provide an inbound request to the endpoint device, the inbound request to direct the operation of the endpoint device.

5. The edge computing network of claim 1, wherein the first outbound request includes a first authentication certificate associated with an authentication authority.

6. The edge computing network of claim 5, wherein, in authenticating the endpoint device, the endpoint orchestrator is further configured to validate the first authentication certificate.

7. The edge computing network of claim 6, wherein the authentication information includes a second authentication certificate associated with the authentication authority.

8. The edge computing network of claim 7, wherein, in authenticating the information handling system, the endpoint device is further configured to validate the second authentication certificate.

9. The edge computing network of claim 1, wherein:
in response to opening the predetermined network port, the endpoint device is further configured to provide an inbound request to the endpoint device; and
the endpoint device includes a control plane and a data plane, and is further configured to determine that the inbound request is addressed to one of the control plane and the data plane.

10. The edge computing network of claim 9, wherein the endpoint device is further configured to allocate bandwidth to the control plane and to the data plane based upon predetermined percentages.

11. A method, comprising:
providing, on an endpoint device, a network interface configured to operate with no open inbound network ports;
providing, on an information handling system, a first reverse proxy and a second reverse proxy;
instantiating, on the information handling system, an endpoint orchestrator;
sending, by the endpoint device, a first outbound request on a predetermined network port;
receiving, by the first reverse proxy, the first outbound request on the predetermined network port;
providing the first outbound request to the second reverse proxy;
providing, by the second reverse proxy, the first outbound request to the endpoint orchestrator;
authenticating the endpoint device based upon the first outbound request;
providing authentication information to the endpoint device to authenticate the information handling system to the endpoint device;
authenticating the information handling system based upon the authentication information; and
opening the predetermined network port to the information handling system in response to authenticating the information handling system.

12. The method of claim 11, wherein, in response to opening the predetermined network port, the method further comprises sending, by the endpoint device, a second outbound request associated with one of a plurality of WebSockets instantiated on the information handling system to the endpoint device.

13. The method of claim 12, further comprising:
receiving, by the first reverse proxy, the second outbound request; and
forwarding the second outbound request to the particular WebSocket.

14. The method of claim 11, wherein, in response to opening the predetermined network port, the method further comprises sending an inbound request to the endpoint device, the inbound request to direct the operation of the endpoint device.

15. The method of claim 11, wherein the first outbound request includes a first authentication certificate associated with an authentication authority.

16. The method of claim 15, wherein, in authenticating the endpoint device, the method further comprises validating the first authentication certificate.

17. The method of claim 16, wherein the authentication information includes a second authentication certificate associated with the authentication authority.

18. The method of claim 17, wherein, in authenticating the information handling system, the method further comprises validating the second authentication certificate.

19. The edge computing network of claim 1, further comprising:
sending a second inbound request to the endpoint device; and
determining, by the endpoint device that the inbound request is addressed to one of a control plane and the data plane of the endpoint device.

20. An edge compute network, comprising:
an endpoint device including a network interface configured to operate with no open inbound network ports and to provide a first outbound request on a predetermined network port; and
an information handling system including a first reverse proxy and a second reverse proxy, and configured to instantiate an endpoint orchestrator, the first reverse proxy configured to receive the first outbound request on the predetermined network port and to provide the first outbound request to the second reverse proxy, the second reverse proxy configured to provide the first outbound request to the endpoint orchestrator, and the endpoint orchestrator configured to authenticate the endpoint device based upon the first outbound request and provide authentication information to the endpoint device to authenticate the information handling system to the endpoint device;
wherein the endpoint device is further configured to authenticate the information handling system based upon the authentication information, and to open the predetermined network port to the information handling system in response to authenticating the information handling system;
wherein, in response to opening the predetermined network port, the endpoint device is further configured to provide a second outbound request associated with one of a plurality of WebSockets instantiated on the information handling system to the endpoint device; and
wherein, in response to opening the predetermined network port, the information handling system is configured to provide an inbound request to the endpoint device, the inbound request to direct the operation of the endpoint device.
